(19) United States
(12) Patent Application Publication
(10) Pub. No.: US 2003/0140054 A1
(43) Pub. Date: Jul. 24, 2003

(54) Processor composing apparatus, system LSI composing apparatus, processor composing method, system LSI composing method, and program therefor

(76) Inventor: Motohide Otsubo, Kanagawa (JP)

Correspondence Address: Darryl G. Walker, WALKER & SAKO, LLP, Suite 235, 300 South First Street, San Jose, CA, 95113, US

(21) Appl. No.: 10/349,465

(22) Filed: Jan. 22, 2003

(30) Foreign Application Priority Data
Jan. 23, 2002 (JP) 2002-014750

(51) Int. Cl. G06F 7/00

(52) U.S. Cl. 707/100

(57) ABSTRACT

A processor composing method that may be capable of flexibly designing an interface of a processor has been disclosed. A behavioral description (1) and an interface definition (2) may be input into a processor composite apparatus (100) which is an operation composite device. A behavioral description (2) may describe functions of a processor. An interface definition (2) may define the interface of a processor. An interface library to be included may be extracted from a library database (3) and an extracted interface library may be included in the behavioral description (1) for composing operations. If only an interface definition (2) is changed without changing the behavioral description (1), a processor of any of a CPU (1), a CPU (2) and a CPU (3) having the same functions may be obtained with a different interface.

### TECHNICAL FIELD

The present invention relates generally to a processor composing apparatus, a system LSI composing apparatus, a processor composing method, and a recording medium, and more particularly to a composing apparatus and method that may be capable of flexibly designing an external interface.

### BACKGROUND OF THE INVENTION

A LSI (large scale integrated circuit) may realize all circuit functions of a system using one chip. Such an LSI is referred to as a SOC (system on chip) or a system LSI. A system LSI can be designed as appropriate for an algorithm to be used and a process. In designing a system LSI, a hardware IP (Intellectual Property) is used. A hardware IP is a hardware macro designed on condition of subsequent reuse.

Referring now to FIG. 13, a block schematic diagram of a conventional system LSI is set forth and given the general reference character 1300. Conventional system LSI 1300 includes a processor 10 and peripheral hardware (21, 22, and 23) interconnected through a bus 30. Processor 10 and peripheral hardware (21, 22, and 23) each include a BUS INTERFACE.

Processor 10 operates based on a software program, and functions as the center of conventional system LSI 1300. Processor 10 reuses the hardware IP, and the design is determined by a processor division that specializes in processor design based on a RT (register transfer) design method. The RT design refers to a design technology of designing hardware using a memory unit such as a register etc. and an arithmetic unit such as an adder etc.

The specifications of bus 30 are determined by a bus interface (BUS INTERFACE) of processor 10. Because the processor is reused as described above, the specifications of bus 30 are determined. When designing a system LSI, the bus interface is designed in accordance with the specifications of bus 30 for newly designed peripheral hardware (21, 22, and 23). In this way, processor 10 and peripheral hardware (21, 22, and 23) transmit/receive data using a communications method based on the specifications of bus 30.

Data may not be directly transmitted/received between two or more processors having different bus specifications and peripheral hardware. Therefore, in order to connect different busses, a bus bridge may be used. Referring now to FIG. 14, a conventional system LSI is set forth in a block, schematic diagram and given the general reference character 1400. Conventional system LSI 1400 includes two different processors (10 and 15). Each processor (10 and 15) is connected to a respective bus (30 and 35). Bus 30 and bus 35 have different specifications. Thus, a bus bridge 40 is connected between bus 30 and 35 and passes data between the busses (30 and 35). Using bus bridge 40, data can be transmitted/received between processor A 10 and processor B 15.

However, using a bus bridge to connect two different busses causes the scale of the hardware to become larger. Additionally, a bus bridge has a low data transfer speed as compared with a common bus and may thus be a bottleneck in process speed.

As described above, the specifications of bus 30 can be determined by the bus interface of a processor. Because the processor is designed based on a RT design, the bus interface cannot be easily changed. Therefore, for example, when processor 15 which has a different bus interface from processor 10 is used in a conventional system LSI 1400, the specifications of the bus is to be changed, and bus interfaces of peripheral hardware (21, 22, and 23) are to be re-designed according to processor 15.

When the processor and peripheral hardware share the same hardware resources in the conventional system LSI and do not simultaneously operate, the hardware resources may be effectively used if the hardware resources (such as an arithmetic unit, a register, etc.) are shared. However, in designing a conventional system LSI 1300, as described above, processor 10 and peripheral hardware (21, 22, and 23) are separately designed, and the processor 10 and peripheral hardware (21, 22, and 23) are connected through a bus 30. Therefore, in a design of a conventional system LSI 1300, it may be difficult to share hardware sources.

A processor may also be capable of performing the functions of peripheral hardware using processor instructions after including the functions of peripheral hardware in the processor. In designing a processor, functions of newly included hardware may be added to the basic configuration of a designed processor. Because the processor reads and executes instructions one by one, an included instruction and a basic configuration instruction does not simultaneously operate. Therefore, the condition of sharing hardware resources between the instructions is satisfied. However, because the basic configuration of the processor is fixed as a hardware macro, it may be difficult to share hardware resources between an included instruction and a basic configuration instruction.

Furthermore, a well known conventional system LSI may include a processor and peripheral hardware that start operations according to an interrupt signal or the like and at least part of the operation overlaps. In such a conventional system LSI, when a processor and peripheral hardware share hardware resources, it may be necessary to provide an adjustment so that operation timings of the processor and peripheral hardware cannot overlap each other. However, because the timing of generating an interrupt signal is normally uncertain, the adjustment can be complicated and sharing hardware resources can be difficult.

In any of the above-mentioned cases, it can be difficult to share hardware resources between processor instructions or between a processor and peripheral hardware. Therefore, the same type of hardware resources have been provided for the processor and peripheral hardware. As a result, the utilization rate of hardware resources is lowered and there is considerable waste. In this way, the circuit scale of a processor and a system LSI can be large and inefficient.

The present invention has been developed to address the above-mentioned problems.

In view of the above discussion, it would be desirable to provide a processor composing apparatus, a system LSI composing apparatus, a processor composing method, a system LSI composing method, and a recording medium that may be capable of arbitrarily composing a processor having a bus interface suitable for a particular specification. In this way, hardware resources may be easily shared.

### SUMMARY OF THE INVENTION

According to the present embodiments, a processor composing method that may be capable of flexibly designing an interface of a processor has been disclosed. A behavioral description and an interface definition may be input into a processor composite apparatus, which may be an operation composite device. A behavioral description may describe functions of a processor. An interface definition may define the interface of a processor. An interface library to be included may be extracted from a library database and an extracted interface library may be included in the behavioral description for composing operations. If only an interface definition is changed without changing the behavioral description, a processor of any of a first CPU, a second CPU, and a third CPU having the same functions may be obtained with a different interface.

According to one aspect of the embodiments, a processor composite apparatus may include a database and an operation composite means. A database may store a plurality of interface libraries. An operation composite means may extract an interface library from the database based on an interface definition, which may be determined on an external condition of a processor and may compose operations by including the extracted interface library in a behavioral description of functions of a processor.

According to another aspect of the embodiments, a processor composite apparatus may include a database and an operation composite means. A database may store a plurality of interface libraries. An operation composite means may extract an interface library from the database based on an interface definition, which may be determined on an external condition of a processor and may compose operations by including the extracted interface library in a behavioral description of functions of plural pieces of hardware including at least a processor.

According to another aspect of the embodiments, a system LSI composite apparatus may include a database and an operation composite means. A database may store a plurality of interface libraries. An operation composite means may extract an interface library from the database based on an interface definition, which may be determined on an external condition of a LSI and may compose operations by including the extracted interface library in a behavioral description of functions of a processor and peripheral hardware.

According to another aspect of the embodiments, a processor composing method may include the steps of extracting an interface library from a database based on an interface definition determined on an external condition of a processor and composing operations by including the extracted interface library in a behavioral description of functions of a processor.

According to another aspect of the embodiments, a processor composing method may include the steps of extracting an interface library from a database based on an interface definition determined on an external condition of a processor and composing operations by including the extracted interface library in a behavioral description of functions of plural pieces of hardware including at least a processor a processor.

According to another aspect of the embodiments, a system LSI composing method may include the steps of extracting an interface library from a database based on an interface definition determined on an external condition of a processor and composing operations by including the extracted interface library in a behavioral description of functions of a processor and peripheral hardware.

According to another aspect of the embodiments, a behavioral description may be described as an array access of peripheral hardware.

According to another aspect of the embodiments, an interface obtained by a composition of operations may connect a bus, a memory, a register, or a network to the processor.

According to another aspect of the embodiments, the operation composite means may output a circuit model described by an RTL description, a gate level description, and a programming language.

According to another aspect of the embodiments, a processor composite apparatus may include a storage device. A storage device may store a behavioral description and an interface definition.

According to another aspect of the embodiments, a plural piece of hardware may perform serial operations and/or parallel operations.

According to another aspect of the embodiments, an interface obtained by the step of composing operations may connect a bus, a memory, a register, or a network to a processor.

According to another aspect of the embodiments, plural pieces of hardware may share at least one hardware resource.

According to another aspect of the embodiments, plural pieces of hardware may not overlap each other in operation timing.

According to another aspect of the embodiments, a behavioral description may be described as an array access of peripheral hardware.

According to another aspect of the embodiments, a recording medium may record a program for realizing a processor composing method or a system LSI composing method.

### BRIEF DESCRIPTION OF THE DRAWINGS

FIG. 1 is a block schematic diagram of a processor composing apparatus according to an embodiment.

FIG. 2 is a flowchart illustrating a procedure of a processor composing method for use with a processor composing apparatus according to an embodiment.

FIG. 3 is a block schematic diagram showing an example of composing a CPU in a processor composing method according to an embodiment.

FIG. 4 is an example of a behavioral description of a declaration of a terminal of an interface library according to an embodiment.

FIG. 5 is a re-write rule of a data reading operation according to an embodiment.

FIG. 6 is a re-write rule of a data writing operation according to an embodiment.

FIG. 7 is an example of including an interface library in a behavioral description shown in FIG. 3 according to an embodiment.

FIG. 8 is a practical example of a processor composing method and an example of serially operation function of peripheral hardware and functions of the processor according to an embodiment.

FIG. 9 is a practical example of a processor composing method showing an example in which the functions of the peripheral hardware can be performed from the function of the CPU according to an embodiment.

FIG. 10 is a practical example of a processor composing method where functions of the peripheral hardware and the functions of the CPU are operated in parallel according to an embodiment.

FIG. 11 is a block schematic diagram of a processor composing apparatus according to an embodiment.

FIG. 12 is an example of composing operations using an interface other than a bus according to an embodiment.

FIG. 13 is a block schematic diagram of a conventional system LSI.

FIG. 14 is a block schematic diagram of a conventional system LSI.

### DETAILED DESCRIPTION OF THE EMBODIMENTS

Various embodiments of the present invention will now be described in detail with reference to a number of drawings.

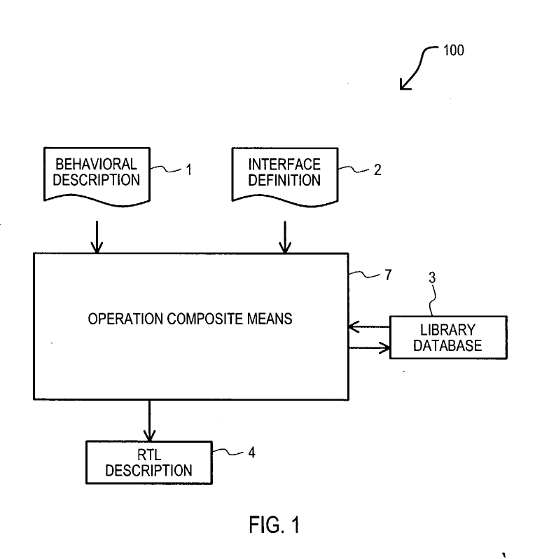

Referring now to FIG. 1, a block schematic diagram of a processor composing apparatus according to an embodiment is set forth and given the general reference character 100.

Processor composing apparatus 100 may include an operation composing means 7 and a library database 3. Operation composing means 7 may provide an RTL description 4. RTL description 4 may be a hardware description based on a behavioral description 1 and an interface definition 2.

In the behavioral description 1, all functions of a processor can be described in a high-level language, such as C language, C++ language, or the like. Interface definition 2 may define the configuration of the interface determined by an external condition such as bus specifications etc. when a process to be obtained is used. Behavioral description 1 and interface definition 2 may be input into operation composing means 7.

Library database 3 may store an interface library. Operation composing means 7 may extract an interface library corresponding to the provided interface definition 2. Operation composing means 7 may include the extracted interface library 3 in the behavioral description 1, and may then perform composing operations. The RTL description may include the RTL description appropriate for hardware and the RTL description appropriate for simulation. Operation composing means 7 may output any or both of the RTL descriptions.

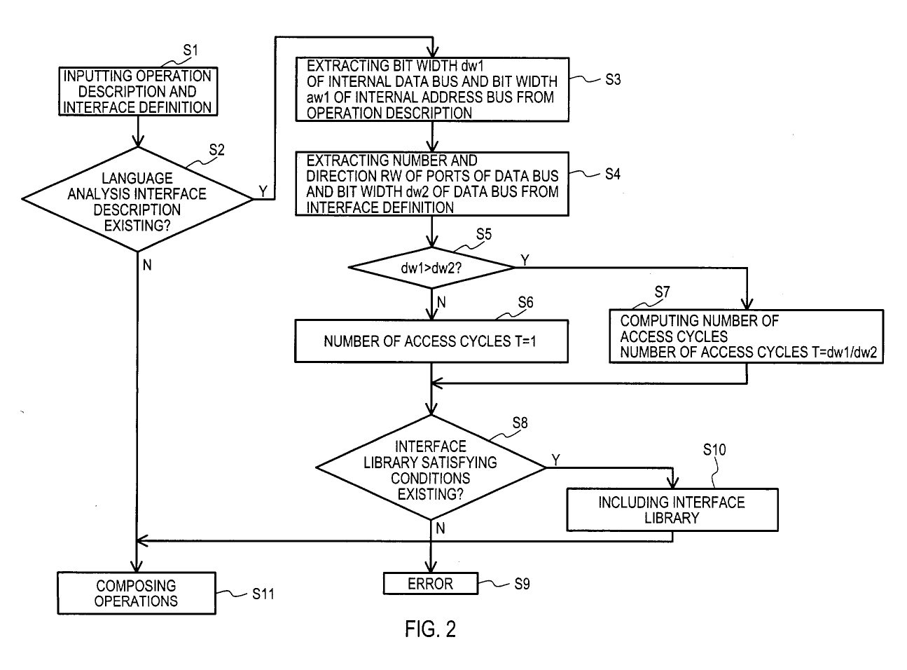

Referring now to FIG. 2, a flowchart illustrating a procedure of a processor composing method for use with a processor composing apparatus according to an embodiment is set forth.

The flowchart of FIG. 2 may illustrate a procedure of a processor composing method for use with a processor composing apparatus 100 of FIG. 1.

In step S1, the behavioral description 1 describing the functions of a processor to be obtained and the interface definition 2 may be input into the processor composing apparatus 100 for composing operations. Then, in step S2, the operation composing means 7 may analyze the language of the behavioral description 1 and check whether or not there is a description prescribing an interface. If there are no descriptions prescribing an interface, control may be passed to step S11. In this case, behavioral description 1 may be composed and RTL description 4 may be output.

However, if in step S2, it is determined that there is an interface description as a result of language analysis, then control may be passed to step S3. In step S3, a bit width dw1 of an inner data bus and a bit width aw1 of an inner address bus may be extracted from the interface description. Then, in step S4, the interface definition 2 may be referred to, and the number and directions of ports of the data bus and the bit width dw2 of the data bus may be extracted. Based on the number and directions of ports of the data bus, a determination may be made as to whether read and write control signals are independent or shared.

In step S5, the bit width dw1 of the inner data bus may be compared with the bit width dw2 of the data bus. If the bit width dw1 of the inner data bus is smaller than the bit width dw2 of the data bus, control may be passed to step S6. In step S6, the number of access cycles T of the data bus may be set to 1. If the bit width dw1 of the inner data bus is larger than the bit width dw2 of the data bus, control may be passed to step S7. In step S7, the number of access cycles T may be set to dw1/dw2, where decimals may be rounded up.

When the number of access cycles T has been determined, in step S8, the operation composing means 7 may search the library database 3 to extract an interface library satisfying all conditions in which the bit width of an address bus is awl or more, the bit width of a data bus is dw2, the number and directions of the ports of the data bus are specified by the interface definition 2, and the number of access cycles is T. If there are no corresponding libraries, control may be passed to step S9 and an error flag may be produced. If there is a corresponding interface library, control may be passed to step S10 where the extracted interface library may be included and control may then be passed to step S11. In step S11, operation composing means 7 may include the extracted interface library for composing operations in the behavioral description 1 and may obtain the RTL description 4 of the processor.

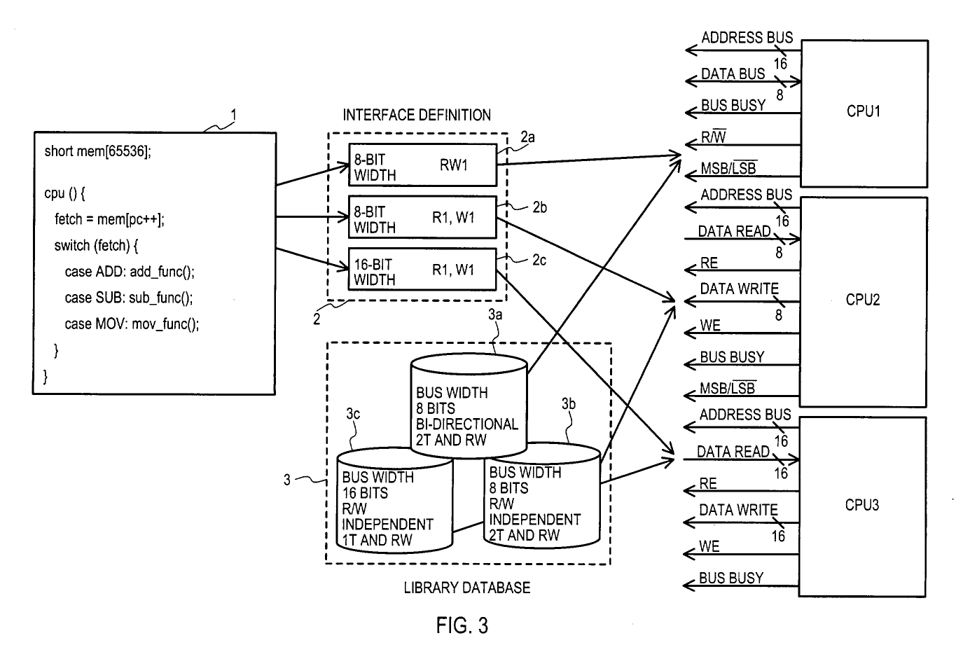

Referring now to FIG. 3, a block schematic diagram showing an example of composing a CPU in a processor composing method according to an embodiment is set forth.

The block schematic diagram of FIG. 3 may be used to describe an example of composing a CPU in a processor composing method according to FIGS. 1 and 2.

In FIG. 3, if the interface definition 2 is provided for the behavioral description 1, then the interface library corresponding to the interface definition 2 extracted from the library database 3 may be included and the operations may be composed. Thus, any processor of CPU 1, CPU 2, or CPU 3 may be composed. Thus, CPUs (1, 2, and 3) of FIG. 3 may be processors having the same functions and can be different in interface configuration.

Furthermore, generating an interface will be practically described below by referring to FIGS. 2 and 3. In the behavioral description 1, all functions of the CPU can be described. In this example, an access memory space is 65,536 (16 bits), and instruction words can be ADD, SUB, and MOV, and may be executed by the respective arithmetic circuits. Because a short type variable can be a 16-bit variable, the processor may fetch a 16-bit instruction word from the memory, and performs a process depending on the contents.

An interface definition 2 may define the interface of the CPU, the width of a data bus, and the directions of the ports of the data bus. In FIG. 3, an interface definition 2a may define an interface having an 8-bit data bus for read/write and bi-directional data transfer. An interface definition 2b may define an interface having an 8-bit data bus for independent read and write and a unidirectional transmission. An interface definition 2c may define an interface having a 16-bit data bus for independent read and write and a unidirectional transmission. When composing operations are undertaken, one of the interface definitions (2a, 2b, and 2c) may be specified. An interface library corresponding to each interface definition 2 may be registered in the library database 3.

In step S3, the operation composing device may extract the inner address bus width aw1 prescribing an access memory space and an inner data bus width dw1 determined by the instruction word length from the behavioral description 1. In this CPU, the inner address bus width aw1 is 16 bits and the inner data bus width dw1 is also 16 bits. Then, in step S4, the number and directions of the ports of a data bus may be extracted from the interface definition 2. In this example, it is assumed that the interface is defined by interface definition 2a. That is, an interface having an 8-bit data bus width dw2 for read/write, and a bi-directional data transfer is specified.

The inner data bus width dw1 (16 bits) may be compared with the data bus width dw2 (8 bits). Because dw1>dw2, control may be passed to step S7 and the number of access cycles T may be computed and set to 2 (in this case). In step S8, with the above-mentioned conditions, that is, the interface library having the address bus width of 16 bits or more, an 8-bit data bus width, for reads/write, a bi-directional data transfer, and the number of access cycles T of 2 may be retrieved from the library database 3. In this case, the corresponding interface library may be the interface library 3a.

When an interface library to be included is determined, the interface library 3a may be included in the behavioral description 1 to compose operations in step S11. With composing operations, the CPU 1 may be obtained. If the interface definition 2b is specified in step S1, the interface library 3b may be included and CPU 2 may be obtained. When the interface definition 2c is specified, the interface library 3c may be included and CPU 3 may be obtained.

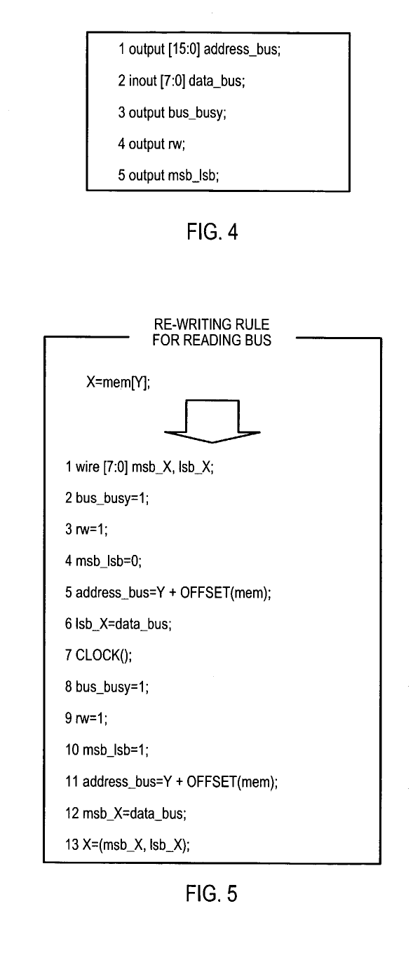

The process of step S10 in which an interface library 3a is included will further be described below in detail by referring to FIGS. 4 to 7. The configuration of interface library 3a may include a declaration of a terminal connected to a bus and a re-write rule portion for re-write of an behavioral description in the operation of an interface. When an interface library is included in the behavioral description, a declaration portion of the terminal may be added to the behavioral description and communications of data through an interface such as a memory access, or the like, may be re-written according to a re-write rule.

Referring now to FIG. 4, an example of an behavioral description of a declaration of a terminal of interface library 3a according to an embodiment is set forth. In FIG. 4, “output” in lines 1 and 3 to 5 may indicate output terminals and “inout” in line 2 may indicate an input/output terminal. “[m:n]” in lines 1 and 2 may indicate a bus line of a plurality of bits having m as a MSB (most significant bit) and n as a LSB (least significant bit). A 16-bit address bus may be defined in line 1 and an 8-bit data bus may be defined in line 2.

Referring now to FIG. 5, a re-write rule of a data reading operation according to an embodiment is set forth. When a library is included, the description of X=mem[Y] in the behavioral description may be re-written into a process indicated in lines 1 to 13. X and Y may indicate a variable which can be appropriately replaced with a variable in the behavioral description.

In line 1, an 8-bit intermediate variable “msb_X” and “lsb_X” may be declared. In line 2, a signal indicating that the bus is in use may be output. In line 3, a signal indicating that a data bus is used in reading may be output. In line 4, a signal indicating that the lower order 8-bit data is to be used in the 16-bit data may be output.

In line 5, an address represented by “Y+OFFSET(mem)” may be output to the address bus. “OFFSET(mem)” may indicate the leading address of the address in the memory and may be provided as a comment in the behavioral description and the declaration portion in the behavioral description or another description than the behavioral description. In line 6, the value of the data bus (the data of the memory of the address indicated by an address bus) may be substituted in the intermediate variable “lsb_X”. In line 7, the clock cycle may be advance by 1.

In lines 8 to 12, essentially the same operations as in lines 2 to 6 may be performed except that higher order 8-bit data may be substituted for the intermediate variable “msb_X”. In line 13, the intermediate variable “msb_X” of the higher order 8-bit and the “lsb_X” of the lower order 8-bit mare be combined into 16-bit data and substituted for the variable “X”.

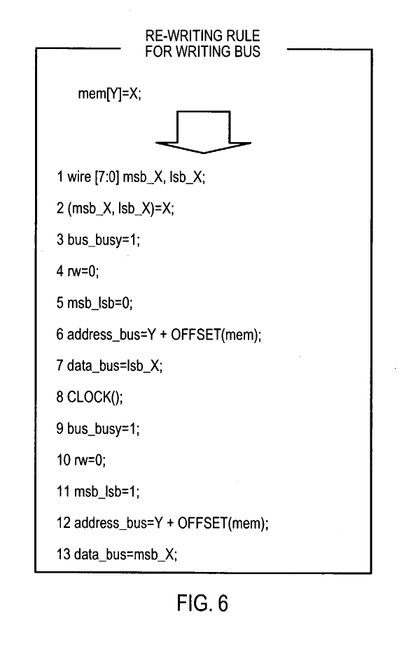

Referring now to FIG. 6, a re-write rule of a data writing operation according to an embodiment is set forth. The data writing operation of FIG. 6 may be different from the data reading operation of FIG. 5 in that, in lines 4 to 10, a signal indicating the data bus is used in writing may be output and data may be written to the memory. If there is a description of “mem[Y]=X” during the behavioral description, then data may be re-written into the processes in lines 1 to 13.

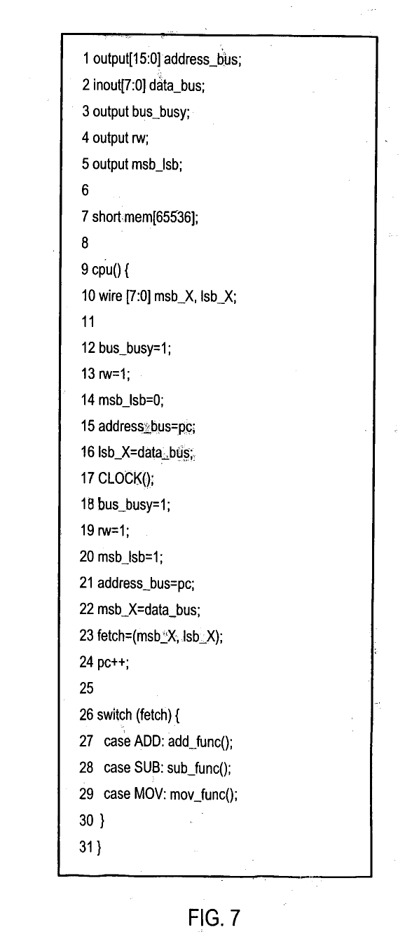

Referring now to FIG. 7, an example of including the interface library 3a in the behavioral description 1 shown in FIG. 3 according to an embodiment is set forth. Behavioral description 1 may be re-written based on the re-write rule shown in FIG. 5 after the declaration portion of a terminal shown in FIG. 4 is added to the leading portion and the “fetch=mem[pc++]” portion is converted into the “fetch=[mem];pc++” portion. During the re-writing operation, “X” and “Y” may be replaced with a variable of an behavioral description as described above. That is, “X” may be replaced with “fetch” and “Y” may be replaced with “pc”. As described above, an interface library may be included. The re-write of “fetch=mem[pc++]” may also be performed before step S10.

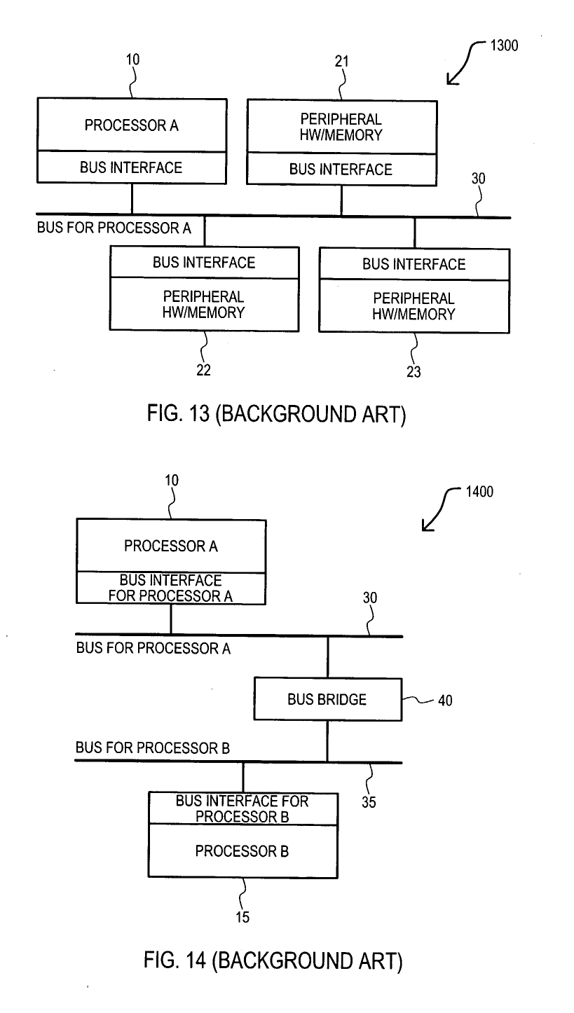

When a processor is composed in the above-mentioned composing method, the bus interface of the processor can be flexibly designed. For example, when processor 10 shown in FIG. 13 is replaced with processor 15, operations may be composed by providing the same interface definition 2 as the bus interface of processor 10 for the behavioral description of processor 15. In this way, processor 15 may be composed. Thus, processor 15 may be directly connected to bus 30 of processor 10 and it may not be necessary to re-design peripheral hardware (21, 22, and 23).

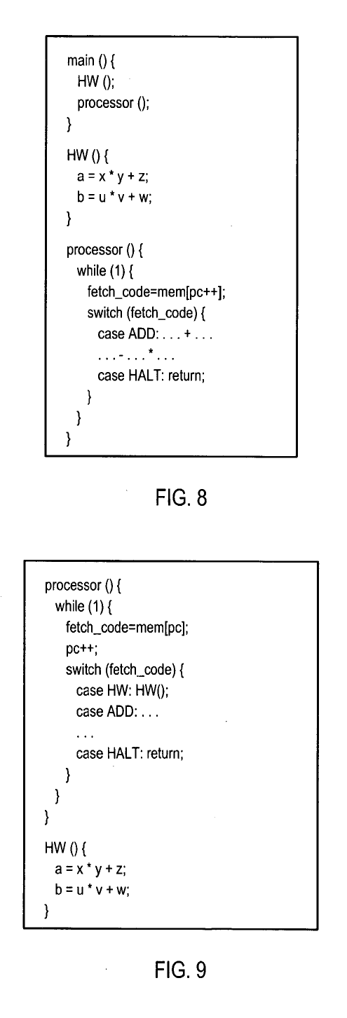

Not only the functions of a single processor, but also the functions of the peripheral hardware configuring a system LSI may be described together in the behavioral description 1 of the processor. Referring now to FIG. 8, a practical example of a processor composing method and an example of serial operation function of peripheral hardware and functions of the processor according to an embodiment is set forth. The embodiment illustrated in FIG. 8 may differ from the embodiment of FIGS. 1 to 7 in the contents of the behavioral description.

In FIG. 8, the main function in the behavioral description may include an HW function and a processor function in series. Operations may be composed according to the above-mentioned descriptions and a processor in which an HW function and a processor function serially operate may be obtained. The function of the peripheral hardware is described in the HW function, and is shown in FIG. 8 as an arithmetic operation by two computation equations. The function of a CPU may be described in the processor function and the process of performing an addition, a multiplication, etc. may be defined according to the instruction word. When the instruction word is “HALT”, the operation of the CPU may be completed.

In a processor obtained in the processor composing method according to the embodiment of FIG. 8, the functions of peripheral hardware may first be operated. When the operation is completed, the functions of the CPU may be performed. In the function of the CPU, an instruction word may be read and a process may be performed according to the instruction word. When the instruction word is not “HALT”, the next instruction word may be read and the process may continue. When the instruction word is “HALT”, then the operation of the CPU may terminate, control may be returned to start, and the functions of peripheral hardware may be performed.

In the description example shown in FIG. 8, the arithmetic resources of an adder (+) and a multiplier (*) can utilize the same hardware sources between the peripheral hardware and the CPU. That is, if the same arithmetic resources are used in the description of the operations to be composed, and the arithmetic resources are not simultaneously used, then the composing process may be performed such that the arithmetic resources can be shared. Therefore, when the behavioral description 1 is used in composing operations, an RTL description in which the hardware resources are shared between the functions of the peripheral hardware and the functions of the CPU may be generated. As another method of composing operations, the arithmetic operation execution order of the behavioral description 1 may be scheduled such that the same arithmetic resources can be shared and then operations may be composed. This operation composing method may also be applied when operations are composed in the processor composing method according to the embodiment of FIG. 8.

Referring now to FIG. 9, a practical example of a processor composing method showing an example in which the functions of the peripheral hardware can be performed from the function of the CPU according to an embodiment is set forth. The processor obtained in the embodiment of FIG. 9 may differ from the processor composing method of the embodiment of FIG. 8 in that the CPU may perform the functions of the peripheral hardware as an include instruction. By composing operations of the description as shown in FIG. 9, hardware resources may be shared as in the embodiment of FIG. 8 and the functions of the CPU may be easily extended.

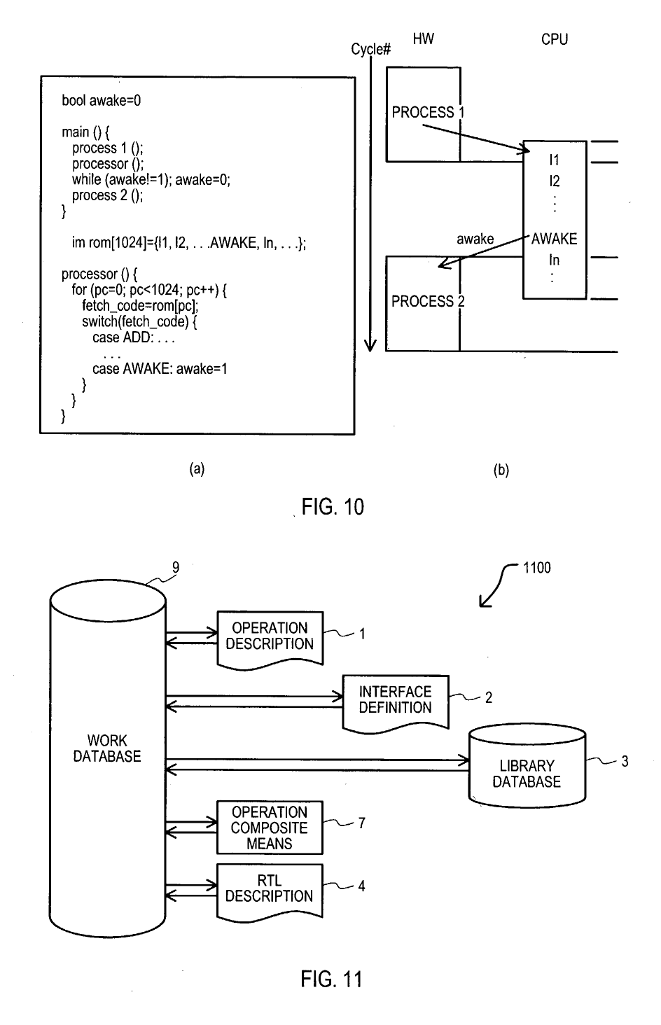

Referring now to FIG. 10, a practical example of a processor composing method where functions of the peripheral hardware and the functions of the CPU are operated in parallel according to an embodiment is set forth. FIG. 10(a) indicates an example of a description and FIG. 10(b) shows an operation flow. The processor obtained in the embodiment of FIG. 10 may differ from the embodiments of FIGS. 1 to 9 in that functions of the peripheral hardware and the functions of the CPU may operate in parallel. In the processor obtained in the embodiment of FIG. 10, as shown in FIG. 10(b), process 1 (which is the function of the peripheral hardware) may be performed and the CPU may start the operation at a predetermined timing. The operations of process 1 and the CPU may be executed at least partially in parallel. In this way, process 1 may be terminated. When the CPU reads the instruction word “AWAKE”, the execution of process 2, which is the function of peripheral hardware may start. The operations of the CPU and process 2 may be executed at least partially in parallel. In this way, the operation of the CPU may be terminated.

When the CPU and the peripheral hardware to be processed in parallel share the same hardware resources, the operation timings may not overlap each other. For example, when the shared memory (the same hardware resources) is shared and accessed in parallel, a schedule may be required such that the access timings do not overlap each other. According to the embodiment of FIG. 10, process 1 and process 2 and the functions of the CPU may be collectively composed. When such operations are composed, the access to the shared memory may be recognized as the access to a same array. Therefore, it may not be necessary for a designer to adjust the program and schedule the access timing to the shared memory. By using the parallelizing system in composing operations, the access timing may be automatically scheduled. In this way, the hardware resources may be easily shared and the memory access may be efficiently performed.

Referring now to FIG. 11, a block schematic diagram of a processor composing apparatus according to an embodiment is set forth and given the general reference character 1100. Processor composing apparatus 1100 may differ from processor composing apparatus 100 of FIG. 1 in that data may be transmitted and received through a work database 9.

Work database 9 may store an behavioral description 1, an interface definition 2, and at least one of the interface libraries extracted from a library database 3. Data may be stored at any time. Work database 9 may also be used to store an intermediate result when an operation composing means 7 performs composing operations. A designer may undertake compose operations by inputting, for example, interface definition 2 stored in work database 9 and a newly described behavioral description 1 into operation composing means 7. In this way, past design resources may be easily reused and work efficiency may thereby be improved.

When an RTL description 4 contains an appropriate RTL description for hardware and an appropriate RTL description for simulation, work database 9 may store a composition condition that the operation composing means 7 output which of the RTL descriptions. By storing the composition condition in work database 9, the step of inputting the composition condition into operation composing means 7 may be omitted.

In the embodiment of FIG. 11, a bus interface may be an example of an interface definition 2, but interface definition 2 is not limited to this application and various interfaces may be defined.

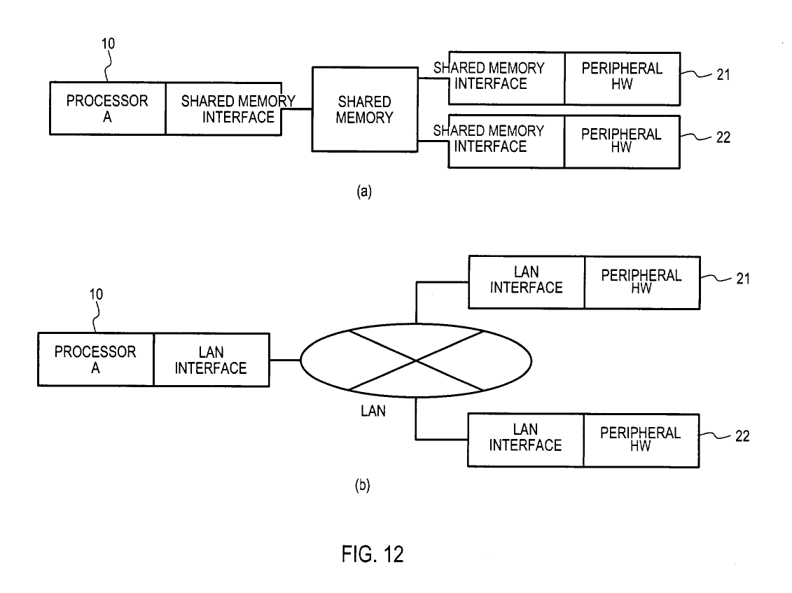

Referring now to FIG. 12, an example of composing operations using an interface other than a bus according to an embodiment is set forth.

FIG. 12(a) illustrates a shared memory interface and FIG. 12(b) illustrates an example including a LAN (local area network) interface.

FIG. 12(a) shows an example of composing operations that can define a shared memory interface according to interface definition 2. A shared memory interface may be provided for the processor and peripheral hardware. In the connection through a bus, there may be a number of bottlenecks in performance due to the problems with the bandwidth of the bus. However, directly accessing the shared memory without a bus may improve the performance.

In addition to a shared memory, as illustrated in FIG. 12(b), a LAN interface may be defined and included. Furthermore, an interface such as a shared register, FIFO (First In—First Out), etc. may be defined and included for the composition of operations. Additionally, when an interface having a complicated protocol such as a LAN or the like is generated, a handshake type interface library may be prepared in the library database to generate an interface in which a processor and a LAN interface may be connected through a handshake type interface.

A processor composing apparatus according to the above-mentioned embodiments may be configured by a computer system such as a work station, a personal computer, etc. A library database may also be configured as an external, storage device connected to the computer system. A behavioral description and an interface definition may be input as a file stored information into the processor composing apparatus, or it may be directly input through a keyboard connected to a computer. Furthermore, the output of the operation composing device may not be limited to the RTL description, but it may be replaced with the configuration of a circuit model and a circuit chart described by a gate level description or a programming language such as C language, C++ language, or the like. In this case, having an output that can be determined by setting an operation composing device may be desirable.

In the above-mentioned processor composing method, all or a portion of peripheral hardware included in a system LSI may be included in the behavioral description of the processor so that the system LSI can be composed. That is, first the functions of the processor and peripheral hardware may be described as a behavioral description. The interface of hardware may be defined based on the external condition of the LSI. An interface library may be retrieved from a predetermined database according to the defined interface. The retrieved interface library may be included in the behavioral description for operation composition. In this way, a system LSI may be successfully obtained.

The present invention has been described above by referring to the embodiments of the present invention, however, the processor composing apparatus, the system LSI composing apparatus, the processor composing method, the system LSI composing method, and the recording medium according to the present embodiments are not limited to the abovementioned embodiments, but may include, for example, the processor composing apparatus, the system LSI composing apparatus, the processor composing method, the system LSI composing method, and the recording medium with various modifications added to them.

As described above, the processor composing apparatus, the system LSI composing apparatus, the processor composing method, the system LSI composing method, and the recording medium according to the embodiments may compose the operations of a processor depending on the specifications of a bus. Therefore, an interface can be flexibly designed. As a result, a processor having different bus specifications may be easily connected to another processor having different bus specifications and peripheral hardware. Furthermore, when operations are composed, the functions of the processor and the functions of peripheral hardware may be collectively composed. As a result, the hardware resources may be easily shared, wasting of hardware resources may be reduced, and the scale of a circuit may be made smaller.

It is understood that the embodiments described above are exemplary and the present invention should not be limited to those embodiments. Specific structures should not be limited to the described embodiments.

Thus, while the various particular embodiments set forth herein have been described in detail, the present invention could be subject to various changes, substitutions, and alterations without departing from the spirit and scope of the invention. Accordingly, the present invention is intended to be limited only as defined by the appended claims.

What is claimed is:

1. A processor composing apparatus, comprising:
a database for storing a plurality of interface libraries; and
an operation composing means for extracting an interface library from the database based on an interface definition based on a condition external to a processor and composing operations by including the extracted interface library in a behavioral description of functions of a processor.

2. The processor composing apparatus according to claim 1, wherein:
the behavioral description is described as an array access of a peripheral hardware function.

3. The processor composing apparatus according to claim 1, wherein:
composing operations form an interface for the processor, the interface connecting to any of the group consisting of a bus, a memory, a register, and a network.

4. The processor composing apparatus according to claim 1, wherein:
the operation composing means outputs a circuit model described by any of the group consisting of a register transfer language (RTL) description, a gate level description, and a programming language.

5. The processor composing apparatus according to claim 1, further including:
a storage device for storing the behavioral description and the interface definition.

6. A processor composing apparatus, comprising:
a database for storing a plurality of interface libraries; and
an operation composing means for extracting an interface library from the database based on an interface definition determined on an external condition of a processor and composing operations by including the extracted interface library in a behavioral description of functions of plural pieces of hardware including at least a processor.

7. The processor composing apparatus according to claim 6, wherein:
the plural pieces of hardware perform operations with respect to a processor in manner selected from the group consisting of serial operations and parallel operations.

8. The processor composing apparatus according to claim 6, wherein:
the behavioral description is described as an array access of a peripheral hardware function.

9. The processor composing apparatus according to claim 6, wherein:
composing operation form an interface for the at least one processor that connects to any of the group consisting of a bus, a memory, a register, and a network to the processor.

10. The processor composing apparatus according to claim 6, wherein:
the operation composing means outputs a circuit chart described by any of the group consisting of an RTL description, a gate level description, and a programming language.

11. The processor composing apparatus according to claim 6, further including:
a storage device for storing the behavioral description and the extracted library interface.

12. A system large scale integrated circuit (LSI) composing apparatus, comprising:
a database for storing a plurality of interface libraries; and
an operation composing means for extracting an interface library from the database based on an interface definition determined independently of the LSI and composing operations by including the extracted interface library in a behavioral description of functions of a processor and peripheral hardware.

13. The system LSI composing apparatus according to claim 12, wherein:
the operation composite means outputs a circuit model described by any from the group consisting of a RTL description, a gate level description, and a programming language.

14. The system LSI composing apparatus according to claim 12, further including:
a storage device for storing the behavioral description and the interface definition.

15. A processor composing method, comprising the steps of:
extracting an interface library from a database based on an interface definition determined on an external condition of a processor; and
composing operations by including the extracted interface library in a behavioral description of functions of a processor.

16. The processor composing method according to claim 15, wherein:
the behavioral description is described as an array access of peripheral hardware functions.

17. The processor composing method according to claim 15, wherein:
an interface obtained by the step of composing operations connects to any selected from the group consisting of a bus, a memory, a register, and a network to the processor.

18. The processor composing method according to claim 15, wherein:
the behavioral description includes a circuit model described by any selected from the group consisting of a RTL description, a gate level description, and a programming language.

19. A computer program embodied on computer-readable medium executable on a computing system, comprising:
a library extraction section that extracts an interface library based on a condition external to a large scale integrated circuit (LSI); and
a composing operations section that includes the extracted interface library in a functional description of a processor.

20. A processor composing method, comprising the steps of:
extracting an interface library from a database based on an interface definition determined on an external condition of a processor; and
composing operations by including the extracted interface library in a behavioral description of functions of plural pieces of hardware including at least a processor.

21. The processor composing method according to claim 20, wherein:
the plural pieces of hardware perform functions with respect to processor functions in manner selected from the group consisting of serial operations and parallel operations.

22. The processor composing method according to claim 20, wherein:
the plural pieces of hardware share at least one hardware resource.

23. The processor composing method according to claim 22, wherein:
the plural pieces of hardware do not overlap each other in operation timing.

24. The processor composing method according to claim 20, wherein:
the behavioral description is described as an array access of a peripheral hardware function.

25. The processor composing method according to claim 20, wherein:
an interface obtained by the step of composing operations connects to any selected from the group consisting of a bus, a memory, a register, and a network to the processor.

26. The processor composing method according to claim 20, wherein:
the behavioral description includes a circuit model described by any selected from the group consisting of a RTL description, a gate level description, and a programming language.

27. A system LSI composing method, comprising the steps of:
extracting an interface library from a database based on an interface definition determined on an external condition of a processor; and
composing operations by including the extracted interface library in a behavioral description of functions of a processor and peripheral hardware.

28. The system LSI composing method according to claim 27, wherein:
the behavioral description includes a circuit model described by any selected from the group consisting of an RTL description, a gate level description, and a programming language.
